(19) United States
(12) Patent Application Publication
(10) Pub. No.: US 2025/0374015 A1
(43) Pub. Date: Dec. 4, 2025

(54) SYSTEMS AND METHODS FOR DELIVERING SHORT MESSAGE SERVICE MESSAGES USING A SHORT MESSAGE SERVICE CENTER

(71) Applicant: Verizon Patent and Licensing Inc., Basking Ridge, NJ (US)

(72) Inventors: Kashif KHAN, Keller, TX (US); Shawn R. PUGH, Easton, PA (US); John Cao Vinh NGUYEN, Trophy Club, TX (US)

(73) Assignee: Verizon Patent and Licensing Inc., Basking Ridge, NJ (US)

(21) Appl. No.: 18/731,683

(22) Filed: Jun. 3, 2024

(51) Int. Cl. H04W 4/14; H04L 65/1016; H04W 8/18

(52) U.S. Cl. CPC H04W 4/14; H04L 65/1016; H04W 8/183

(57) ABSTRACT

In some implementations, a device may receive a short message service (SMS) message for delivery to a user equipment (UE). The device may attempt an SMS message delivery to the UE via a first network. The device may determine that the SMS message delivery via the first network has failed. The device may attempt the SMS message delivery via a second network. The device may determine that the SMS message delivery via the second network is successful. The device may set an indicator to skip the first network for a subsequent SMS message for the UE. The device may receive the subsequent SMS message for delivery to the UE. The device may deliver, based on the indicator, the subsequent SMS message to the UE using the second network.

### BACKGROUND

Wireless communication systems are widely deployed to provide various telecommunication services such as telephony, video, data, messaging, and broadcasts. A wireless network may include one or more network nodes that support communication for wireless communication devices, such as a user equipment (UE).

### BRIEF DESCRIPTION OF THE DRAWINGS

FIG. 1 is a diagram of an example associated with a short message service (SMS) architecture.

FIG. 2 is a diagram of an example associated with a user equipment (UE) registration status awareness at a short message service center (SMSC).

FIG. 3 is a flow diagram of an example associated with SMS message delivery.

FIG. 4 is a flow diagram of an example associated with SMS message delivery.

FIG. 5 is a diagram of an example environment in which systems and/or methods described herein may be implemented.

FIG. 6 is a diagram of example components of one or more devices of FIG. 5.

FIG. 7 is a flowchart of an example process associated with delivering SMS messages using an SMSC.

### DETAILED DESCRIPTION OF EXAMPLE EMBODIMENTS

The following detailed description of example implementations refers to the accompanying drawings. The same reference numbers in different drawings may identify the same or similar elements.

An SMSC is a network element in a wireless network that handles text message operations. The SMSC may be responsible for receiving, storing, routing, and/or forwarding SMS messages from UEs. The SMSC may also be referred to as an SMS application server (AS) (SMS-AS).

When a UE moves from Long Term Evolution (LTE) coverage to Global System for Mobile communication (GSM) coverage, an Internet Protocol (IP) multimedia subsystem (IMS) de-registration may not occur for the UE, which may result in a mobile terminated (MT) SMS message delivery with a lengthy delay (e.g., approximately 3060 seconds). The delay may be due to the UE still indicating that it is still IMS registered in a home subscriber server (HSS), which may trigger the SMSC to send the SMS message to IMS (e.g., an IMS network), even though the UE is no longer in LTE coverage and has already moved to GSM coverage. The SMSC may always attempt to initially deliver the SMS message via IMS, which may result in the delay. After a period of time, the SMSC may check with the HSS as to whether the UE is available in a circuit-switched (CS) domain (e.g., whether the UE is in GSM coverage). The HSS may confirm that the UE is in GSM coverage, at which point the SMSC may deliver the SMS message to the UE via GSM (e.g., a GSM network). However, such delay in delivering the SMS message may result in a degraded network performance and poor user experience.

In some implementations, when the UE is showing as IMS registered and the UE has actually moved to GSM coverage without de-registering from IMS, and the SMSC verifies with the HSS that the UE is in GSM coverage, then the SMSC may subsequently deliver all SMS messages directly to GSM without attempting to deliver to IMS. In other words, all subsequent attempts will deliver an SMS message directly to GSM without attempting to deliver to IMS, which aids in avoiding the delay in delivering the SMS message. As part of an enhanced SMSC for MT delivery, the SMSC may not query the HSS each time the SMS message is attempted to be delivered via IMS and is unsuccessful. The SMSC may become aware of a UE registration status (e.g., the UE is outside of LTE coverage but has not de-registered from IMS), and then the SMSC may apply that awareness of the UE registration status for subsequent SMS message deliveries, such that the SMSC does not query the HSS each time the SMS message is to be delivered to the UE. While a first SMS message may experience the delay (e.g., approximately 30-60 seconds) because the SMSC is not initially aware that the UE is in GSM coverage, subsequent SMS messages may not suffer from the delay because the SMSC may not query the HSS and instead may directly deliver the SMS messages via GSM. An indicator, such as a “skip IMS” flag may be set, which may allow the SMSC to bypass IMS and directly send the SMS messages via GSM. If the UE re-registers with IMS, then the “skip IMS” flag may be cleared, at which point, the SMS may first deliver an SMS message to IMS. As a result, SMS messages may be delivered in a timely manner, especially when the UE is roaming in an area that has a large GSM coverage but is still showing as IMS registered.

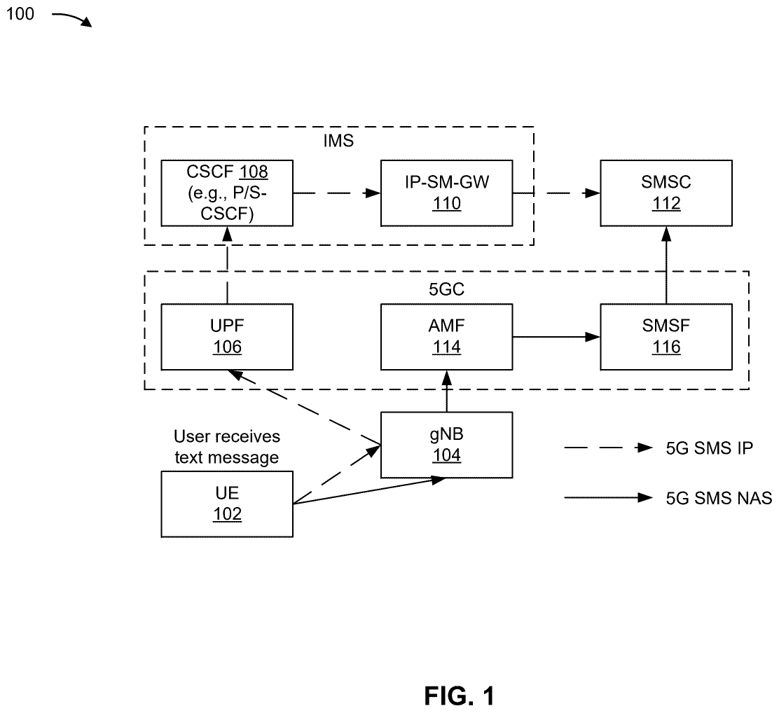

FIG. 1 is a diagram of an example 100 associated with an SMS architecture. As shown in FIG. 1, example 100 includes a UE 102, an eNB or gNB 104, a user plane function (UPF) 106, a call session control function (CSCF) 108 (e.g., a proxy CSCF (P-CSCF) and/or a serving CSCF (S-CSCF)), an IP short message (SM) gateway (IP-SM-GW) 110, an SMSC 112, an access and mobility management function (AMF) 114, and a short messaging service function (SMSF) 116. The UPF 106, the AMF 114, and the SMSF 116 may be associated with a 5G core (5GC). The CSCF 108 and the IP-SM-GW 110 may be associated with an IMS.

As shown in FIG. 1, in a Fifth Generation (5G) SMS IP signaling approach, the UE 102 may receive a text message from the SMSC 112 via the gNB 104, the UPF 106, the CSCF 108, and the IP-SM-GW 110. Alternatively, in a 5G SMS non-access stratum (NAS) signaling approach, the UE 102 may receive a text message from the SMSC 112 via the gNB 104, the AMF 114, and the SMSF 116. The SMSC 112 may be a network element responsible for handling SMS messaging. The SMSC may be involved in an SMS MT for a Fourth Generation (4G) system or a 5G system.

As indicated above, FIG. 1 is provided as an example. Other examples may differ from what is described with regard to FIG. 1. The number and arrangement of devices shown in FIG. 1 are provided as an example. In practice, there may be additional devices, fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

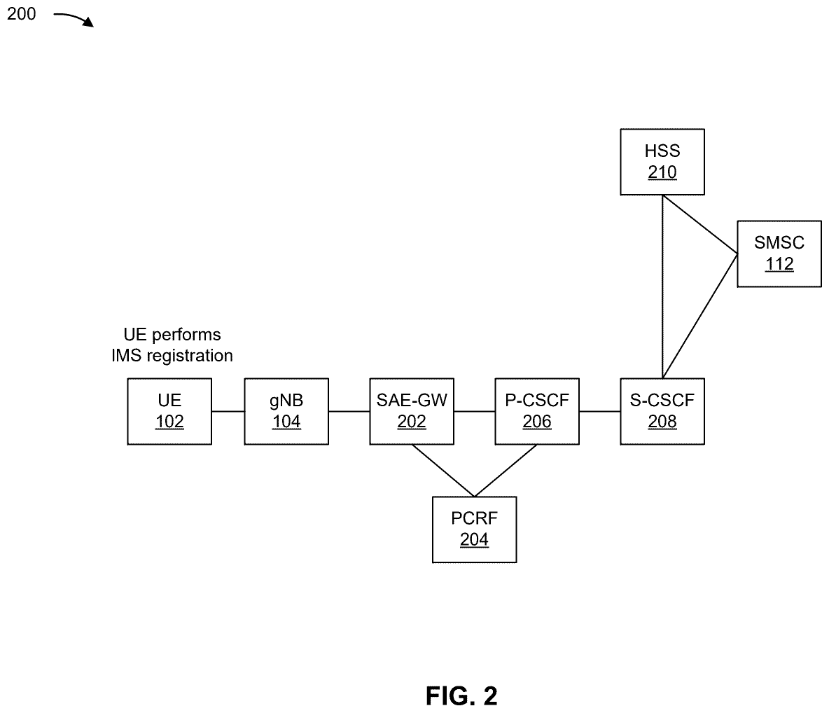

FIG. 2 is a diagram of an example 200 associated with a UE registration status awareness at an SMSC. As shown in FIG. 2, example 200 includes a UE 102, an eNB or gNB 104, a system architecture evolution (SAE) gateway (GW) (SAE-GW) 202, a policy and charging rules function (PCRF) 204, a P-CSCF 206, an S-CSCF 208, an HSS 210, and an SMSC 112.

As shown in FIG. 2, the UE 102 may perform an IMS registration, which may involve signaling between the UE 102, the gNB 104, the SAE-GW 202, the PCRF 204, the P-CSCF 206, the S-CSCF 208, and/or the HSS 210. New initial filter criteria (iFC) may be created that will trigger the S-CSCF 208 to send a third party registration to the SMSC 112, which may allow the SMSC 112 to become aware when the UE 102 registers or when the UE 102 de-registers with an IMS network. In other words, when the UE 102 performs the IMS registration, the S-CSCF 208 may notify the SMSC 112 of the IMS registration. When the UE 102 performs an IMS de-registration, the S-CSCF 208 may notify the SMSC 112 of the IMS de-registration. As a result, the SMSC 112 may be aware of the UE's registration status.

In some implementations, the SMSC 112 may provide a mechanism to deliver an SMS message to the UE 102 in a timely manner when the UE 102 roams into a GSM coverage only area. The SMSC 112 may be enhanced to support a “skip IMS” flag in local registration data. The “skip IMS” flag may be set when an SMS MT delivery is attempted to IMS (e.g., an IMS network) and fails, and a subsequent SMS MT delivery to GSM (e.g., a GSM network) is successful. The SMS MT delivery may be an SMS message delivery. The SMS MT delivery may be attempted with an assumption that the UE 102 is an IMS registered UE, but the SMS MT delivery may fail. When the SMS MT delivery is attempted with an assumption that the UE 102 is in a GSM network, the SMS MT delivery may be successful. When the “skip IMS” flag is set, then for all subsequent SMS MT deliveries, the SMSC 112 may attempt the SMS MT delivery to GSM by default (e.g., not IMS). In other words, the SMSC 112 may skip the SMS MT delivery to IMS and only attempt the SMS MT delivery to GSM. The “skip IMS” flag may be cleared when a next IMS registration is initiated by the UE 102. After the next IMS registration, the SMSC 112 may no longer deliver SMS messages to GSM by default, and instead may deliver the SMS messages to IMS.

In some implementations, in an IMS network architecture, the new iFC may be introduced for the SMSC 112. The S-CSCF 208 may forward a register message to the SMSC 112 based on the new iFC. The register message may indicate the IMS registration of the UE 102. The register message may be of a third party registration in an IMS. Alternatively, the S-CSCF 208 may forward a de-register message to the SMSC 112 based on the new iFC. The SMSC 112 may be enhanced to support receiving the register message and store a UE registration status in the UE's local registration data, where the UE registration status may be based on the register message.

In some implementations, the “skip IMS” flag may be set (e.g., set to 1) when an SMS MT delivery is attempted to an IMS registered UE on IMS and fails, and an SMS MT delivery to GSM is successful. The “skip IMS” flag may be reset (e.g., set to 0) when the register message is received by the SMSC 112 and the “skip IMS” flag is currently set to 1. The “skip IMS” flag may be reset when a third party registration with an expire header that is not 0 is received by the SMSC 112, and the “skip IMS” flag is currently set to 1. In other words, the “skip IMS” flag may be reset when the UE 102 performs an IMS registration. When the “skip IMS” flag is set to 1, the SMSC 112 may first attempt the SMS MT delivery to the GSM.

In some implementations, the SMSC 112 may keep track of an expiry of the IMS registration. When the IMS registration expires, the local registration data and the “skip IMS” flag may no longer be used. At this point, the SMSC 112 may revert back to its original logic to always deliver the SMS message to IMS first (e.g., clear the “skip IMS” flag). In some implementations, the SMSC 112 may keep track of GSM delivery attempts. When the delivery of an SMS MT to GSM fails three times while the “skip IMS” flag is set, then the “skip IMS” flag may be cleared.

In some implementations, setting the “skip IMS” flag may result in the SMSC 112 favoring GSM over LTE for a duration of a registration interval, but the UE 112 may indeed be reachable in an LTE coverage even after a successful GSM MT delivery. The UE 112 may have previously been in an LTE coverage hole, and then the UE 112 may move to an area with adequate LTE coverage. In this case, the UE 112 may now have adequate LTE coverage but GSM may be favored. However, a drawback may be minimal when considering an overall impact of the SMS MT delivery when the UE is only in GSM coverage.

As indicated above, FIG. 2 is provided as an example. Other examples may differ from what is described with regard to FIG. 2. The number and arrangement of devices shown in FIG. 2 are provided as an example. In practice, there may be additional devices, fewer devices, different devices, or differently arranged devices than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) shown in FIG. 2 may perform one or more functions described as being performed by another set of devices shown in FIG. 2.

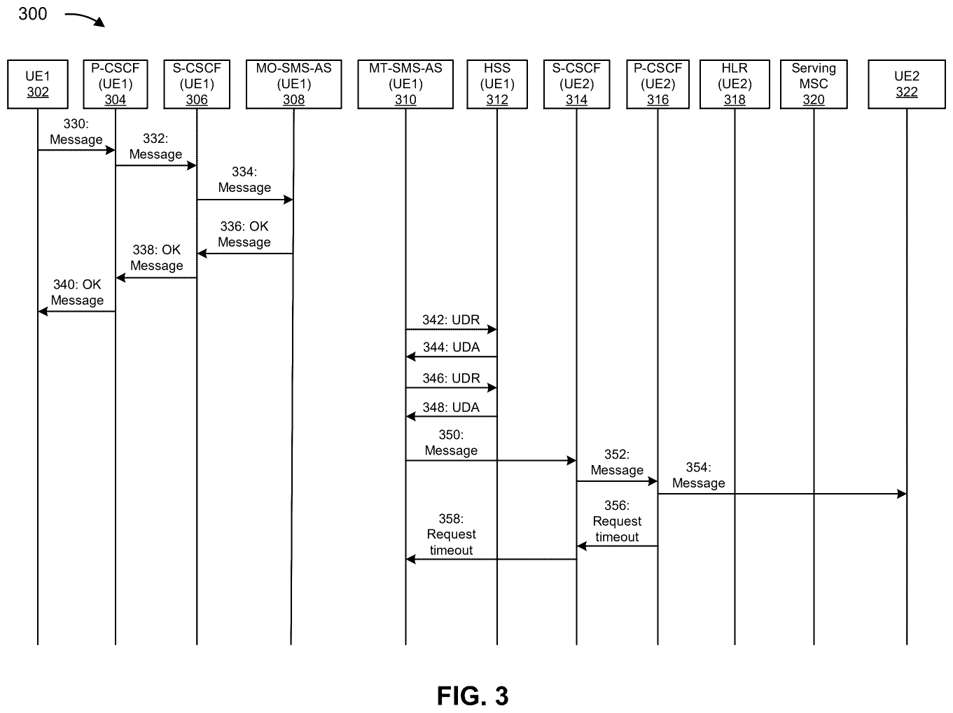

FIG. 3 is a diagram of an example associated with SMS message delivery. As shown in FIG. 3, example 300 includes a first UE 302 (UE1), a first P-CSCF 304, a first S-CSCF 306, a mobile originated (MO)-SMS-AS 308, an MT-SMS-AS 310, an HSS 312, a second S-CSCF 314, a second P-CSCF 316, a home location register (HLR) 318, a serving mobile switch center (MSC) 320, and a second UE 322 (UE2). The first P-CSCF 304, the first S-CSCF 306, the MO-SMS-AS 308, the MT-SMS-AS 310, and the HSS 312 may be associated with the first UE. The second S-CSCF 314, the second P-CSCF 316, and the HLR 318 may be associated with the second UE.

As shown by reference number 330, as part of an SMS-MT call delivery with a delivery preference provisioned to IMS and GSM, the first UE 302 may transmit a message to the first P-CSCF 304. The message may be associated with a content type, and the message may be an SMS encapsulated peer-to-peer (P2P) message. The message may be a session initiation protocol (SIP) message. As shown by reference number 332, the first P-CSCF 304 may forward the message to the first S-CSCF 306. As shown by reference number 334, the first S-CSCF 306 may forward the message to the MO-SMS-AS 308 based on filter criteria. The filter criteria may be used to route the message to an appropriate SMS-AS. As shown by reference number 336, the MO-SMS-AS 308 may transmit an acknowledgement (e.g., a 200 OK message) to the first S-CSCF 306. As shown by reference number 338, the first S-CSCF 306 may forward the acknowledgement to the first P-CSCF 304. As shown by reference number 340, the first P-CSCF 304 may forward the acknowledgement to the first UE 302.

In some implementations, the MO-SMS-AS 308 (MO-SMSC) may perform originating services and route the message to the MT-SMS-AS 310 (MT-SMSC). For example, the MO-SMS-AS 308 may exchange short message delivery point to point (SMDPP) messages with the MT-SMS-AS 310. The MT-SMS-AS 310 may check a subscriber type, determine an HSS address, check a registration status of the second UE 322, and deliver the message accordingly.

As shown by reference number 342, the MT-SMS-AS 310 may transmit a user data request (UDR) to the HSS 312, where the UDR may be for an IMS user status. As shown by reference number 344, the HSS 312 may transmit a user data answer (UDA) to the MT-SMS-AS 310, where the UDA may indicate a registered user state. As shown by reference number 346, the MT-SMS-AS 310 may transmit a UDR to the HSS 312, where the UDR may be for an S-CSCF name. As shown by reference number 348, the HSS 312 may transmit a UDA to the MT-SMS-AS 310, where the UDA may indicate a fully qualified domain name (FQDN) of the second S-CSCF 314.

As shown by reference number 350, the MT-SMS-AS 310 may transmit the message to the second S-CSCF 314. As shown by reference number 352, the second S-CSCF 314 may forward the message to the second P-CSCF 316. As shown by reference number 354, the second P-CSCF 316 may forward the message to the second UE 322. However, the second P-CSCF 316 may not receive any response from the second UE 322 because the second UE 322 may be in GSM coverage and no longer in LTE coverage. As shown by reference number 356, the second P-CSCF 316 may transmit a request timeout message to the second S-CSCF 314. The request timeout message may only be transmitted after a delay. As shown by reference number 358, the second S-CSCF 314 may forward the request timeout message to the MT-SMS-AS 310. The MT-SMS-AS 310 may then attempt to deliver the message via GSM. However, due to the delay, the MT-SMS-AS 310 may not attempt to deliver the message GSM in a timely manner.

As indicated above, FIG. 3 is provided as an example. Other examples may differ from what is described with regard to FIG. 3. The number and arrangement of devices shown in FIG. 3 are provided as an example. In practice, there may be additional devices, fewer devices, different devices, or differently arranged devices than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) shown in FIG. 3 may perform one or more functions described as being performed by another set of devices shown in FIG. 3.

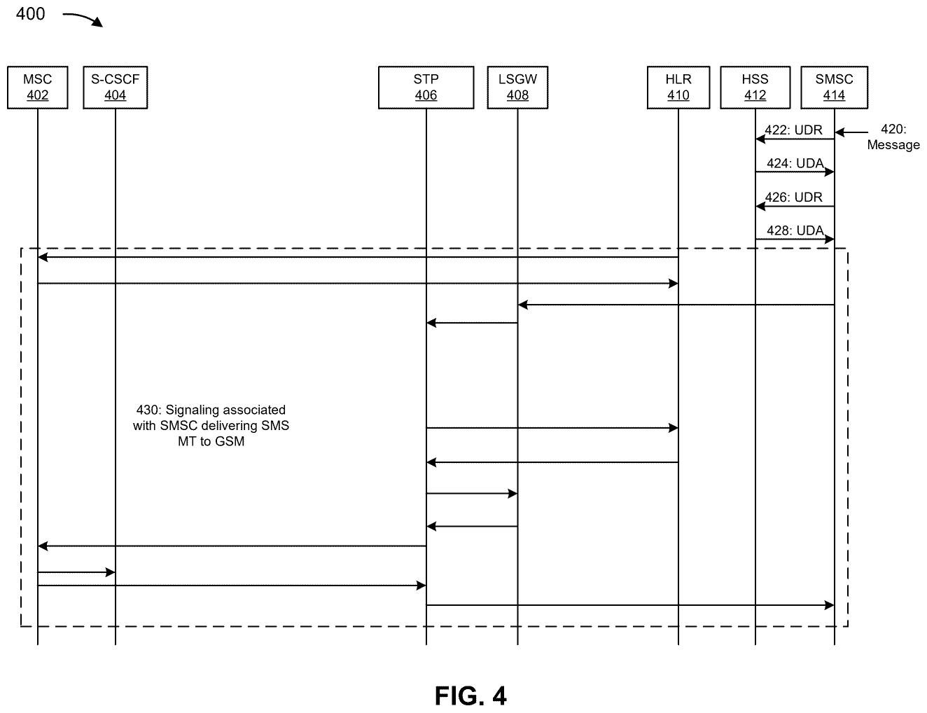

FIG. 4 is a diagram of an example 400 associated with SMS message delivery. As shown in FIG. 4, example 400 includes an MSC 402, an S-CSCF 404, a signaling transfer point (STP) 406, an LTE SMS gateway (LSGW) 408, an HLR 410, a home subscriber server (HSS) 412, and an SMSC 414.

As shown by reference number 420, as part of an MT SMS to user roaming in GSM and a delivery preference provisioned to IMS and GSM, the SMSC 414 may receive a message. The message may be associated with a content type, and the message may be an SMS encapsulated P2P message. As shown by reference number 422, the SMSC 414 may transmit a UDR to the HSS 412, where the UDR may be for an IMS user state. As shown by reference number 424, the HSS 412 may transmit a UDA to the SMSC 414, where the UDA may indicate that the IMS user state is not available. As shown by reference number 426, the SMSC 414 may transmit a UDR to the HSS 312, where the UDR may be for a CS domain. As shown by reference number 428, the HSS 312 may transmit a UDA to the SMSC 414.

In some implementations, the SMSC 414 may attempt to deliver the message to a UE via IMS, where the UE may be intended to receive message. As shown by reference number 430, when the UE does not respond in IMS, the SMSC 414 may assume that the UE is not in an IMS network but rather may be in a GSM network, so the SMSC 414 may communicate signaling associated with delivering an SMS MT to GSM. The signaling may involve the MSC 402, the S-CSCF 404, the STP 406, the LSGW 408, the HLR 410, the HSS 412, and/or the SMSC 414, which may cause the message to be delivered to the UE via GSM.

In some implementations, the SMSC 414 may attempt to deliver the SMS MT to GSM when the UE does not respond in IMS. In other words, delivering the SMS MT to IMS may fail, but delivering the SMS MT to IMS may be successful. When an SMS MT delivery that is attempted to an IMS registered device on IMS fails and a subsequent SMS MT delivery to GSM is successful, a “skip IMS” flag may be set. For all subsequent SMS MT deliveries, when the “skip IMS” flag is set, the SMSC 414 may proceed to deliver the SMS MT to GSM (e.g., skip IMS altogether). The “skip IMS” flag may be cleared once the SMSC 414 receives a third party registration associated with the UE.

As indicated above, FIG. 4 is provided as an example. Other examples may differ from what is described with regard to FIG. 4. The number and arrangement of devices shown in FIG. 4 are provided as an example. In practice, there may be additional devices, fewer devices, different devices, or differently arranged devices than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) shown in FIG. 4 may perform one or more functions described as being performed by another set of devices shown in FIG. 4.

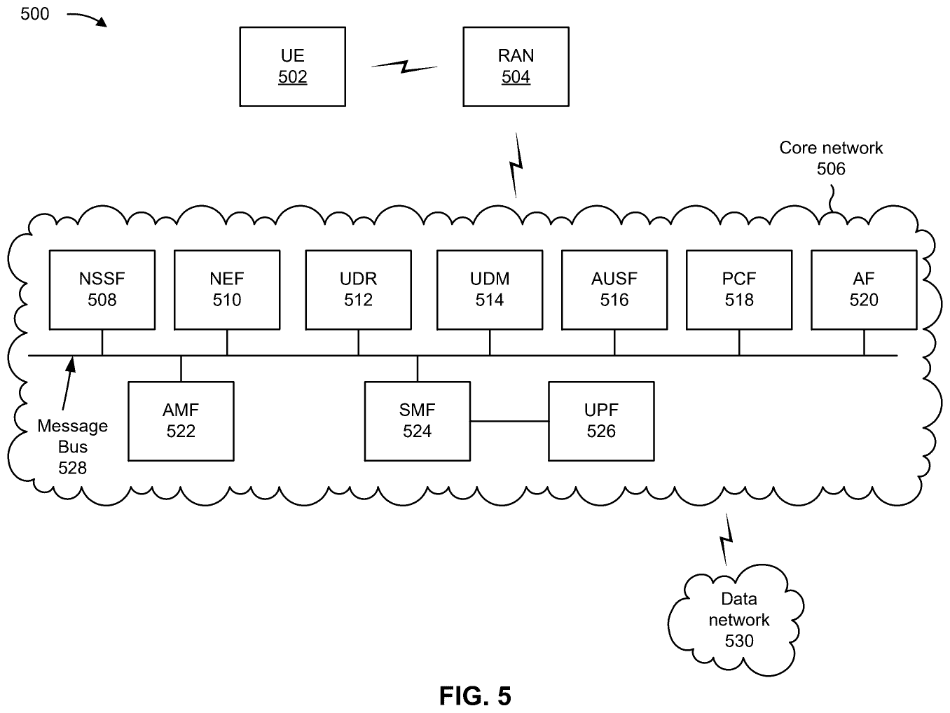

FIG. 5 is a diagram of an example environment 500 in which systems and/or methods described herein may be implemented. As shown in FIG. 5, example environment 500 may include a UE 502, a radio access network (RAN) 504, a core network 506, and a data network 530. Devices and/or networks of example environment 500 may interconnect via wired connections, wireless connections, or a combination of wired and wireless connections.

The UE 502 may include one or more devices capable of receiving, generating, storing, processing, and/or providing information, such as information described herein. For example, the UE 502 can include a mobile phone (e.g., a smart phone or a radiotelephone), a laptop computer, a tablet computer, a desktop computer, a handheld computer, a gaming device, a wearable communication device (e.g., a smart watch or a pair of smart glasses), a mobile hotspot device, a fixed wireless access device, customer premises equipment, an autonomous vehicle, or a similar type of device.

The RAN 504 may support, for example, a cellular radio access technology (RAT). The RAN 504 may include one or more base stations (e.g., base transceiver stations, radio base stations, node Bs, eNodeBs (eNBs), gNodeBs (gNBs), base station subsystems, cellular sites, cellular towers, access points, transmit receive points (TRPs), radio access nodes, macrocell base stations, microcell base stations, picocell base stations, femtocell base stations, or similar types of devices) and other network entities that can support wireless communication for the UE 502. A base station may be a disaggregated base station. The disaggregated base station may be configured to utilize a protocol stack that is physically or logically distributed among two or more nodes, which may include a radio unit (RU), a distributed unit (DU), and a centralized unit (CU). The RAN 504 may transfer traffic between the UE 502 (e.g., using a cellular RAT), one or more base stations (e.g., using a wireless interface or a backhaul interface, such as a wired backhaul interface), and/or the core network 506. The RAN 504 may provide one or more cells that cover geographic areas.

In some implementations, the RAN 504 may perform scheduling and/or resource management for the UE 502 covered by the RAN 504 (e.g., the UE 502 covered by a cell provided by the RAN 504). In some implementations, the RAN 504 may be controlled or coordinated by a network controller, which may perform load balancing, network-level configuration, and/or other operations. The network controller may communicate with the RAN 504 via a wireless or wireline backhaul. In some implementations, the RAN 504 may include a network controller, a self-organizing network (SON) module or component, or a similar module or component. In other words, the RAN 504 may perform network control, scheduling, and/or network management functions (e.g., for uplink, downlink, and/or sidelink communications of the UE 502 covered by the RAN 504).

In some implementations, the core network 506 may include an example functional architecture in which systems and/or methods described herein may be implemented. For example, the core network 506 may include an example architecture of a 5G next generation (NG) core network included in a 5G wireless telecommunications system. While the example architecture of the core network 506 shown in FIG. 5 may be an example of a service-based architecture, in some implementations, the core network 506 may be implemented as a reference-point architecture and/or a 4G core network, among other examples.

As shown in FIG. 5, the core network 506 may include a number of functional elements. The functional elements may include, for example, a network slice selection function (NSSF) 508, a network exposure function (NEF) 510, a unified data repository (UDR) 512, a unified data management (UDM) 514, an authentication server function (AUSF) 516, a policy control function (PCF) 518, an application function (AF) 520, an AMF 522, a session management function (SMF) 524, and/or a UPF 526. These functional elements may be communicatively connected via a message bus 528. Each of the functional elements shown in FIG. 5 is implemented on one or more devices associated with a wireless telecommunications system. In some implementations, one or more of the functional elements may be implemented on physical devices, such as an access point, a base station, and/or a gateway. In some implementations, one or more of the functional elements may be implemented on a computing device of a cloud computing environment.

The NSSF 508 may include one or more devices that select network slice instances for the UE 502. The NSSF 508 may allow an operator to deploy multiple substantially independent end-to-end networks potentially with the same infrastructure. In some implementations, each slice may be customized for different services. The NEF 510 may include one or more devices that support exposure of capabilities and/or events in the wireless telecommunications system to help other entities in the wireless telecommunications system discover network services.

The UDR 512 may include one or more devices that provide a converged repository, which may be used by network functions to store data. For example, a converged repository of subscriber information may be used to service a number of network functions. The UDM 514 may include one or more devices to store user data and profiles in the wireless telecommunications system. The UDM 514 may generate authentication vectors, perform user identification handling, perform subscription management, and perform other various functions. The AUSF 516 may include one or more devices that act as an authentication server and support the process of authenticating the UE 502 in the wireless telecommunications system.

The PCF 518 may include one or more devices that provide a policy framework that incorporates network slicing, roaming, packet processing, and/or mobility management, among other examples. The AF 520 may include one or more devices that support application influence on traffic routing, access to the NEF 510, and/or policy control, among other examples. The AMF 522 may include one or more devices that act as a termination point for non-access stratum (NAS) signaling and/or mobility management, among other examples. The SMF 524 may include one or more devices that support the establishment, modification, and release of communication sessions in the wireless telecommunications system. For example, the SMF 524 may configure traffic steering policies at the UPF 526 and/or may enforce UE internet protocol (IP) address allocation and policies, among other examples. The UPF 526 may include one or more devices that serve as an anchor point for intra-RAT and/or inter-RAT mobility. The UPF 526 may apply rules to packets, such as rules pertaining to packet routing, traffic reporting, and/or handling user plane QoS, among other examples. The message bus 528 may represent a communication structure for communication among the functional elements. In other words, the message bus 528 may permit communication between two or more functional elements.

The data network 530 may include one or more wired and/or wireless data networks. For example, the data network 530 may include an IMS, a public land mobile network (PLMN), a local area network (LAN), a wide area network (WAN), a metropolitan area network (MAN), a private network such as a corporate intranet, an ad hoc network, the Internet, a fiber optic-based network, a cloud computing network, a third party services network, an operator services network, and/or a combination of these or other types of networks.

The number and arrangement of devices and networks shown in FIG. 5 are provided as an example. In practice, there may be additional devices and/or networks, fewer devices and/or networks, different devices and/or networks, or differently arranged devices and/or networks than those shown in FIG. 5. Furthermore, two or more devices shown in FIG. 5 may be implemented within a single device, or a single device shown in FIG. 5 may be implemented as multiple, distributed devices. Additionally, or alternatively, a set of devices (e.g., one or more devices) of example environment 500 may perform one or more functions described as being performed by another set of devices of example environment 500.

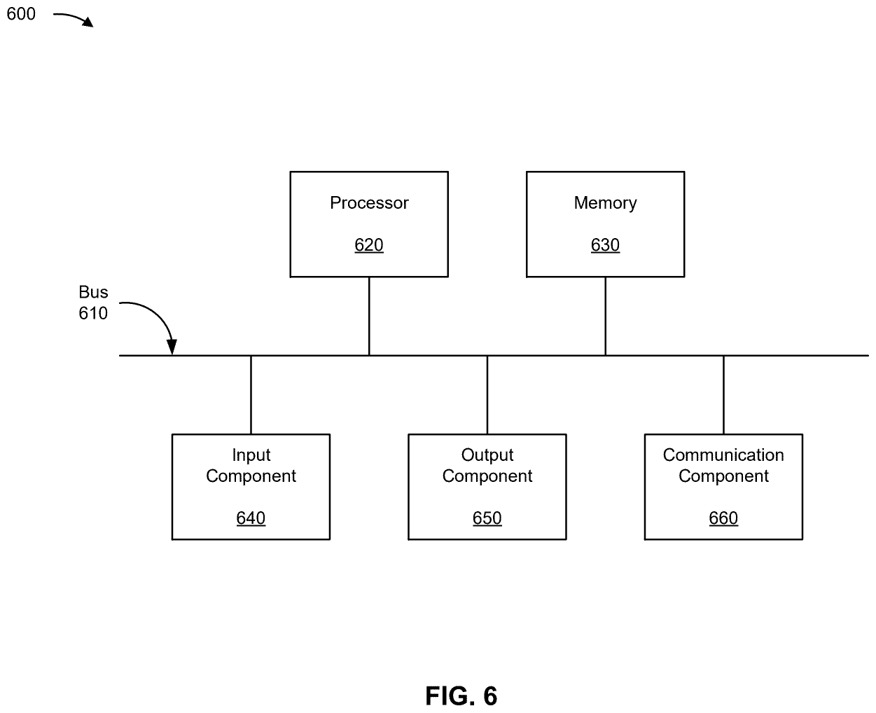

FIG. 6 is a diagram of example components of a device 600 associated with delivering SMS messages using an SMSC. The device 600 may correspond to an SMSC (e.g., SMSC 112). In some implementations, the SMSC may include one or more devices 600 and/or one or more components of the device 600. As shown in FIG. 6, the device 600 may include a bus 610, a processor 620, a memory 630, an input component 640, an output component 650, and/or a communication component 660.

The bus 610 may include one or more components that enable wired and/or wireless communication among the components of the device 600. The bus 610 may couple together two or more components of FIG. 6, such as via operative coupling, communicative coupling, electronic coupling, and/or electric coupling. For example, the bus 610 may include an electrical connection (e.g., a wire, a trace, and/or a lead) and/or a wireless bus. The processor 620 may include a central processing unit, a graphics processing unit, a microprocessor, a controller, a microcontroller, a digital signal processor, a field-programmable gate array, an application-specific integrated circuit, and/or another type of processing component. The processor 620 may be implemented in hardware, firmware, or a combination of hardware and software. In some implementations, the processor 620 may include one or more processors capable of being programmed to perform one or more operations or processes described elsewhere herein.

The memory 630 may include volatile and/or nonvolatile memory. For example, the memory 630 may include random access memory (RAM), read only memory (ROM), a hard disk drive, and/or another type of memory (e.g., a flash memory, a magnetic memory, and/or an optical memory). The memory 630 may include internal memory (e.g., RAM, ROM, or a hard disk drive) and/or removable memory (e.g., removable via a universal serial bus connection). The memory 630 may be a non-transitory computer-readable medium. The memory 630 may store information, one or more instructions, and/or software (e.g., one or more software applications) related to the operation of the device 600. In some implementations, the memory 630 may include one or more memories that are coupled (e.g., communicatively coupled) to one or more processors (e.g., processor 620), such as via the bus 610. Communicative coupling between a processor 620 and a memory 630 may enable the processor 620 to read and/or process information stored in the memory 630 and/or to store information in the memory 630.

The input component 640 may enable the device 600 to receive input, such as user input and/or sensed input. For example, the input component 640 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 650 may enable the device 600 to provide output, such as via a display, a speaker, and/or a light-emitting diode. The communication component 660 may enable the device 600 to communicate with other devices via a wired connection and/or a wireless connection. For example, the communication component 660 may include a receiver, a transmitter, a transceiver, a modem, a network interface card, and/or an antenna.

The device 600 may perform one or more operations or processes described herein. For example, a non-transitory computer-readable medium (e.g., memory 630) may store a set of instructions (e.g., one or more instructions or code) for execution by the processor 620. The processor 620 may execute the set of instructions to perform one or more operations or processes described herein. In some implementations, execution of the set of instructions, by one or more processors 620, causes the one or more processors 620 and/or the device 600 to perform one or more operations or processes described herein. In some implementations, hardwired circuitry may be used instead of or in combination with the instructions to perform one or more operations or processes described herein. Additionally, or alternatively, the processor 620 may be configured to perform one or more operations or processes described herein. Thus, implementations described herein are not limited to any specific combination of hardware circuitry and software.

The number and arrangement of components shown in FIG. 6 are provided as an example. The device 600 may include additional components, fewer components, different components, or differently arranged components than those shown in FIG. 6. Additionally, or alternatively, a set of components (e.g., one or more components) of the device 600 may perform one or more functions described as being performed by another set of components of the device 600.

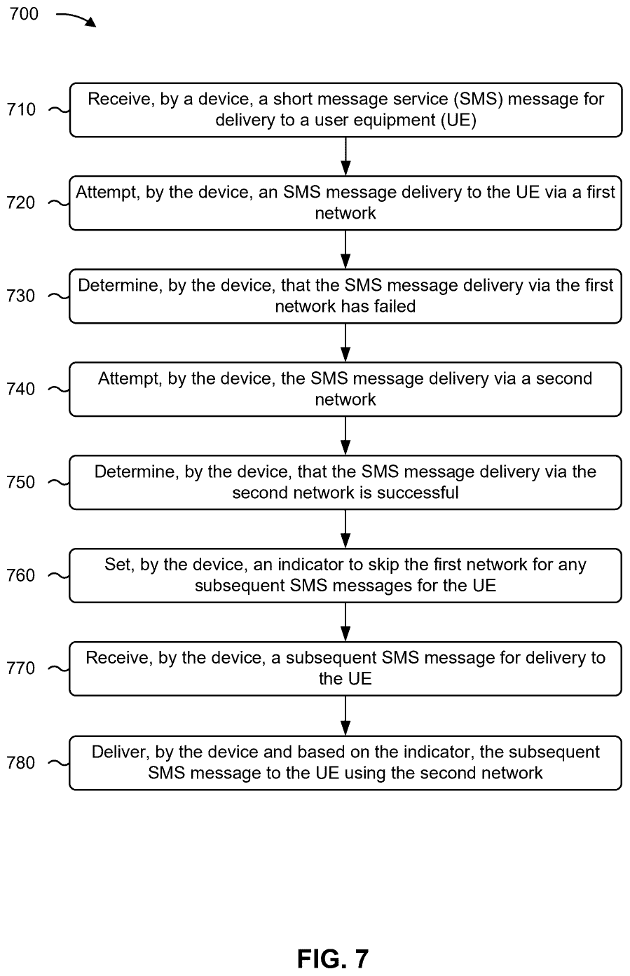

FIG. 7 is a flowchart of an example process 700 associated with delivering SMS messages using an SMSC. In some implementations, one or more process blocks of FIG. 7 may be performed by a device (e.g., SMSC 112). In some implementations, one or more process blocks of FIG. 7 may be performed by another entity or a group of entities separate from or including the SMSC. Additionally, or alternatively, one or more process blocks of FIG. 7 may be performed by one or more components of device 600, such as processor 620, memory 630, input component 640, output component 650, and/or communication component 660.

As shown in FIG. 7, process 700 may include receiving, by the device, an SMS message for delivery to a UE (block 710). The SMS message may be a text message that is intended for the UE. The SMS message may be sent by another UE, and the device may be responsible for routing the SMS message to the UE.

As shown in FIG. 7, process 700 may include attempting, by the device, an SMS message delivery to the UE via a first network (block 720). The first network may be associated with IMS. The device may attempt to deliver the SMS message to the UE via IMS.

As shown in FIG. 7, process 700 may include determining, by the device, that the SMS message delivery via the first network has failed (block 730). The device may determine that the SMS message was not successfully received by the UE, which may be based on the device not receiving any acknowledgement from the UE. A lack of acknowledgement from the UE may indicate that the SMS was not received by the UE.

As shown in FIG. 7, process 700 may include attempting, by the device, the SMS message delivery via a second network (block 740). The second network may be associated with GSM. The device may attempt to deliver the SMS message to the UE via GSM, which may be based on the delivery attempt of the SMS via IMS being unsuccessful.

As shown in FIG. 7, process 700 may include determining, by the device, that the SMS message delivery via the second network is successful (block 750). The device may determine that the SMS message was successfully received by the UE via GSM, which may be based on the device receiving an acknowledgement from the UE.

As shown in FIG. 7, process 700 may include setting, by the device, an indicator to skip the first network for any subsequent SMS messages for the UE (block 760). The indicator may be a “skip IMS” flag, which may cause the device to skip IMS for subsequent SMS messages for the UE. Instead, the device may attempt to deliver the subsequent SMS messages for the UE via GSM, which may involve bypassing IMS altogether.

As shown in FIG. 7, process 700 may include receiving, by the device, a subsequent SMS message for delivery to the UE (block 770). The device may receive the subsequent SMS message at a later point in time, and the subsequent SMS message may be for the UE.

As shown in FIG. 7, process 700 may include delivering, by the device and based on the indicator, the subsequent SMS message to the UE using the second network (block 780). The device may deliver the subsequent SMS message directly via GSM, and the device may not even attempt to deliver the subsequent SMS message via IMS.

In some implementations, the device may receive, from the UE, a registration request to register with the first network. The UE may clear the indicator, which may stop skipping the first network for subsequent SMS messages. In some implementations, the device may detect that a UE registration with the first network has expired. The UE may clear the indicator, which may stop skipping the first network for subsequent SMS messages.

In some implementations, the device may receive, from an S-CSCF, an indication of a UE registration status, wherein the UE registration status indicates whether the UE is registered with the first network or the second network. The device may store the UE registration status as part of local registration data. In some implementations, the device may refrain from querying a network element to check whether the UE is available in the second network, in response to a failure of the SMS message delivery via the first network. In some implementations, the device may detect that a number of delivery attempts for the subsequent SMS message exceeds a threshold. The device may clear the indicator, which may stop skipping the first network for subsequent SMS messages.

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations.

Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, a short message service (SMS) message for delivery to a user equipment (UE);
attempting, by the device, an SMS message delivery to the UE via a first network;
determining, by the device, that the SMS message delivery via the first network has failed;
attempting, by the device, the SMS message delivery via a second network;
determining, by the device, that the SMS message delivery via the second network is successful;
setting, by the device, an indicator to skip the first network for any subsequent SMS messages for the UE;
receiving, by the device, a subsequent SMS message for delivery to the UE; and
delivering, by the device and based on the indicator, the subsequent SMS message to the UE using the second network.

2. The method of claim 1, wherein the device is a short message service center (SMSC), the first network is associated with Internet Protocol multimedia subsystem (IMS), and the second network is associated with Global System for Mobile communication (GSM).

3. The method of claim 1, further comprising:
receiving, by the device, a registration request to register with the first network; and
clearing, by the device, the indicator, to stop skipping the first network for subsequent SMS messages.

4. The method of claim 1, further comprising:
detecting, by the device, that a UE registration with the first network has expired; and
clearing, by the device, the indicator, to stop skipping the first network for subsequent SMS messages.

5. The method of claim 1, further comprising:
receiving, by the device, an indication of a UE registration status, wherein the UE registration status indicates whether the UE is registered with the first network or the second network; and
storing, by the device, the UE registration status as part of local registration data.

6. The method of claim 1, further comprising:
refraining, by the device, from querying a network element to check whether the UE is available in the second network, in response to a failure of the SMS message delivery via the first network.

7. The method of claim 1, further comprising:
detecting, by the device, that a number of delivery attempts for the subsequent SMS message exceeds a threshold; and
clearing, by the device, the indicator, to stop skipping the first network for subsequent SMS messages.

8. A device, comprising:
one or more processors configured to:
receive a short message service (SMS) message for delivery to a user equipment (UE);
attempt an SMS message delivery to the UE via a first network;
determine that the SMS message delivery via the first network has failed;
attempt the SMS message delivery via a second network;
determine that the SMS message delivery via the second network is successful;
set a flag to skip the first network for a subsequent SMS message for the UE;
receive the subsequent SMS message for delivery to the UE; and
deliver, based on the flag, the subsequent SMS message to the UE using the second network.

9. The device of claim 8, wherein the device is a short message service center (SMSC), the first network is associated with Internet Protocol multimedia subsystem (IMS), and the second network is associated with Global System for Mobile communication (GSM).

10. The device of claim 8, wherein the one or more processors are further configured to:
receive a registration request to register with the first network; and
clear the flag, to stop skipping the first network for subsequent SMS messages.

11. The device of claim 8, wherein the one or more processors are further configured to:
detect that a UE registration with the first network has expired; and
clear the flag, to stop skipping the first network for subsequent SMS messages.

12. The device of claim 8, wherein the one or more processors are further configured to:
receive an indication of a UE registration status, wherein the UE registration status indicates whether the UE is registered with the first network or the second network; and
store the UE registration status as part of local registration data.

13. The device of claim 8, wherein the one or more processors are further configured to:
refrain from querying a network element to check whether the UE is available in the second network, in response to a failure of the SMS message delivery via the first network.

14. The device of claim 8, wherein the one or more processors are further configured to:
detect that a number of delivery attempts for the subsequent SMS message exceeds a threshold; and
clear the flag, to stop skipping the first network for subsequent SMS messages.

15. A non-transitory computer-readable medium storing a set of instructions, the set of instructions comprising:
one or more instructions that, when executed by one or more processors of a device, cause the device to:
receive a short message service (SMS) message for delivery to a user equipment (UE);
attempt an SMS message delivery to the UE via a first network;
determine that the SMS message delivery via the first network has failed;
attempt the SMS message delivery via a second network;
determine that the SMS message delivery via the second network is successful;
set a flag to skip the first network for a subsequent SMS message for the UE;
receive the subsequent SMS message for delivery to the UE; and
deliver, based on the flag, the subsequent SMS message to the UE using the second network.

16. The non-transitory computer-readable medium of claim 15, wherein the device is a short message service center (SMSC), the first network is associated with Internet Protocol multimedia subsystem (IMS), and the second network is associated with Global System for Mobile communication (GSM).

17. The non-transitory computer-readable medium of claim 15, wherein the one or more instructions, when executed by the one or more processors, further cause the device to:
receive a registration request to register with the first network; and
clear the flag, to stop skipping the first network for subsequent SMS messages.

18. The non-transitory computer-readable medium of claim 15, wherein the one or more instructions, when executed by the one or more processors, further cause the device to:
detect that a UE registration with the first network has expired; and
clear the flag, to stop skipping the first network for subsequent SMS messages.

19. The non-transitory computer-readable medium of claim 15, wherein the one or more instructions, when executed by the one or more processors, further cause the device to
receive an indication of a UE registration status, wherein the UE registration status indicates whether the UE is registered with the first network or the second network; and
store the UE registration status as part of local registration data.

20. The non-transitory computer-readable medium of claim 15, wherein the one or more instructions, when executed by the one or more processors, further cause the device to:
detect that a number of delivery attempts for the subsequent SMS message exceeds a threshold; and
clear the flag, to stop skipping the first network for subsequent SMS messages.
